(19) United States
(12) Patent Application Publication
(10) Pub. No.: US 2024/0183171 A1
(43) Pub. Date: Jun. 6, 2024

(54) SYSTEM AND METHOD FOR MANUFACTURING A PRODUCT HAVING AN AESTHETIC, DURABLE, COST EFFECTIVE AND WEATHER RESISTANT COATING IN WIDER DIMENSIONS AND CAPABLE OF INSTALLATION IN DIFFERENT ORIENTATIONS

(71) Applicant: Synergy Prime, LLC, Los Gatos, CA (US)

(72) Inventors: Hamid MORADI, Isfahan (IR); Matthew ESMAEILI, San Jose, CA (US)

(73) Assignee: Synergy Prime, LLC, Los Gatos, CA (US)

(21) Appl. No.: 18/378,973

(22) Filed: Oct. 11, 2023

Related U.S. Application Data
(60) Provisional application No. 63/415,237, filed on Oct. 11, 2022.

(51) Int. Cl. E04F 13/08; B29C 43/30; B29C 48/00; B29C 48/07; B29K 27/06; B29L 31/10; E04F 13/18

(52) U.S. Cl. CPC E04F 13/0894; B29C 43/305; B29C 48/0023; E04F 13/18; B29C 48/0011; B29C 48/002; B29C 48/07; B29K 2027/06; B29L 2031/10; E04F 13/0876; E04F 2201/0107; E04F 2201/023; E04F 2201/043

(57) ABSTRACT

A system for executing manufacturing process or method for producing product is disclosed. The product may be vinyl siding panels. In accordance with the various aspects and embodiments of the invention, the manufacturing process uses a coating (the print) that is very opaque and provides very high weatherability against the UV rays of sunlight. The product has a unique design, which makes it possible to install the product in both horizontal and vertical orientations. The product can be produced in a variety of widths, including wider than normal market sizes. The product includes the features of special design and patterns to replicate the appearance of natural material with the added advantage of permanent and lasting appearance. Further, the product is made using a manufacturing process that includes the ability to use economical recycled materials.

### TECHNICAL FIELD

The present technology is in the field of manufacturing and, more precisely, relates to production and manufacturing of vinyl siding.

### BACKGROUND

Historically, vinyl siding is not particularly attractive and degrades in time due to exposure to sunlight and weather conditions. Furthermore, existing vinyl sidings have low weatherability and gradually faded, which ruins the building's appearance. Additionally, environmental pollution may cause them to look dirty. Another important point regarding existing vinyl sidings is the lack of using recycled materials, which has made these products not eco-friendly.

The low curb appeal of vinyl siding can cause decreased property value for resale homes. Older vinyl siding can allow water to penetrate at the seams between panels to cause damage to the underlying structure.

Some of the sidings available on the market are manufactured or produced by coextrusion to make them fade resistant and to improve their weatherability. Coextrusion is a two-step extrusion of Acrylonitrile Styrene Acrylate (ASA) or Poly Methyl Methacrylate (PMMA) for the top layer and of Polyvinyl Chloride (PVC) for the bottom layer. Because of the difficulty of recycling PVC-A plastic grades, this material is not much recycled and is mostly buried. Coextrusion sidings have reasonable weatherability; however, they lack the capability of allowing special designs and patterns created on them resulting in a look similar to ordinary sidings. Moreover, to connect the two polymers, special substances ASA, and PVC, are required. It is therefore impossible to use less costly recycled materials.

Most of the existing vinyl sidings in the market have a simple appearance, and considering the significant impact that building facades have on their appearance and the fact that new facades in the market have more attractive appearance, the consumption of vinyl sidings in the market is declining.

In some sidings, a transfer film is used to create more realistic patterns. However, as the print is placed on a polyester film or silicon sheet the transfer and emboss are made in one step. The resulting design will not have the required glassiness and precision of print. Therefore, what is needed is a lower cost vinyl siding that can use recycled PVC with a long-lasting attractive look, high durability, minimal fading, and minimal potential for sun damage.

### SUMMARY

Systems and methods are disclosed for a manufacturing process of a product (such as vinyl sidings) that solves the forementioned problems with an innovative solution and creates high attractiveness in terms of design and color. In accordance with the various aspects and embodiments of the invention, the manufacturing process produces a product (vinyl siding) with a special coating. In accordance with the various aspects and embodiments of the invention, the manufacturing process uses a unique transfer system.

One advantage is that the product can have any appearance. Another advantage is that the product has high weatherability because the coating, has high weatherability, adding to its durability against sun exposure. In accordance with the various aspects and embodiments of the invention, the manufacturing process uses a coating (the print) that is very opaque. Thus, due to its special coating, offers a very high weatherability against the UV rays of sunlight. Accordingly, another advantage is that the UV light cannot penetrate it to get to the substrate and, thus, the recycled PVC substrate does not need to be produced with a high weatherability rating. Yet another advantage is that the product is economical to manufacture and uses an eco-friendly production or manufacturing process.

Another advantage is that the product is a vinyl siding that has a flat appearance and is very similar to wood, stone, or stucco, which solves the problem of the simple appearance of existing vinyl sidings.

Another advantage is that the product has the ability to be produced with approximately 95% recycled materials.

Another advantage is that the manufacturing process of applying the coating and transferring it to the surface of the substrate is designed in a way that ensures achieving a uniform coating on the surface of the substrate.

Another advantage is that the manufacturing process uses a transfer system to adhere the coating to the substrate in two stages, which, in addition to not requiring a release layer, enables the production of a matte or glossy finish as required.

Another advantage is that the coating creates a very suitable property for remaining clean and not requiring excessive cleaning.

In accordance with the various aspects and embodiments of the invention, the manufacturing process produces a product with a unique top coating and an innovative procedure for applying it to the PVC surface that is made of recycled PVC. Another advantage is that this allows for the capability of producing realistic looking patterns with high resolution. Rather, the physical properties of the PVC substrate and the optical properties of the unique top coating would become a focus for this invention. In accordance with the various aspects and embodiments of the invention, the product has a special formulation made of 95% recycled materials has been created to achieve a higher physical resistance in the substrate. The special formulation combined with the innovative coating has produced siding with stronger physical resistance and high weatherability. A thicker product can be produced because low cost recycled raw materials are being used for the PVC base. Thus, another advantage is that the product has a larger flat surface area per panel.

In accordance with the various aspects and embodiments of the invention, the manufacturing process allows for transfer of the top coating to the PVC base so that the print and emboss occur with a higher precision. In accordance with the various aspects and embodiments of the invention, the film used can be recycled for re-use because a release layer (in previous methods, another layer was applied to the film to assist the removal of the coating during the transfer process, which is called, “release layer”) is not required.

In accordance with the various aspects and embodiments of the invention, another advantage is that the manufacturing process produces the strongest and widest siding panels in the industry, that can be installed horizontally or vertically. The uniqueness of the design makes it possible to install the siding panels in both horizontal and vertical settings. One advantage is that the resulting product (siding panel) has a beautiful curb appeal and can be made with recycled materials.

### BRIEF DESCRIPTION OF THE DRAWINGS

In order to understand the invention more fully, a reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through the use of the accompanying drawings.

FIG. 1 shows a cross-section of coating before attachment to a substrate in accordance with the various aspects and embodiments of the invention.

FIG. 2 shows a cross-section of a portion of the coating of FIG. 1 attached to a substrate in accordance with the various aspects and embodiments of the invention.

FIG. 3 shows a system for manufacturing or producing a product in accordance with various aspects and embodiments of the invention.

FIG. 4 shows a product (vinyl siding) including connectors in accordance with the various aspects and embodiments of the invention.

FIG. 5A and FIG. 5B show a system for manufacturing the product in accordance with the various aspects and embodiments of the invention.

FIG. 6 shows an unrolling machine portion of the system of FIG. 5A and FIG. 5B in accordance with the various aspects and embodiments of the invention.

FIG. 7 shows a rolling machine portion of the system of FIG. 5A and FIG. 5B in accordance with the various aspects and embodiments of the invention.

FIG. 8A and FIG. 8B show transfer roller machine portion of the system of FIG. 5A and FIG. 5B show an in accordance with the various aspects and embodiments of the invention.

FIG. 9 shows an embossing roller machine portion of the system of FIG. 5A and FIG. 5B in accordance with the various aspects and embodiments of the invention.

### DETAILED DESCRIPTION

The following describes various examples of the present technology used in manufacturing processes that illustrate various aspects and embodiments of the invention. Generally, examples can use the described aspects in any combination. All statements herein reciting principles, aspects, and embodiments, as well as specific examples thereof, are intended to encompass both structural and functional equivalents thereof. The examples provided are intended as non-limiting examples. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one aspect,” “an aspect,” “certain aspects,” “various aspects,” or similar language means that a particular aspect, feature, structure, or characteristic described in connection with any embodiment is included in at least one embodiment of the invention.

Appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting aspects and embodiments of the invention are intended to encompass both structural and functional equivalents thereof. It is intended that such equivalents include both currently known equivalents and equivalents developed in the future.

In accordance with the various aspects and embodiments of the invention, the manufacturing process is disclosed along with a system that executes the manufacturing process to produce a product, which may be a new siding in accordance with the various aspects and embodiments of the invention. As disclosed herein, the product is presented with a unique coating in various designs and colors. As disclosed herein, the substrate of the product is PVC, which is designed with a special formula and has acceptable weatherability and high impact resistance. As disclosed herein, the difference between the product (produce in accordance with the various aspects and embodiments of the invention) and existing vinyl sidings is its coating layer on the PVC sheet, which brings its advantages, the size, and the thickness.

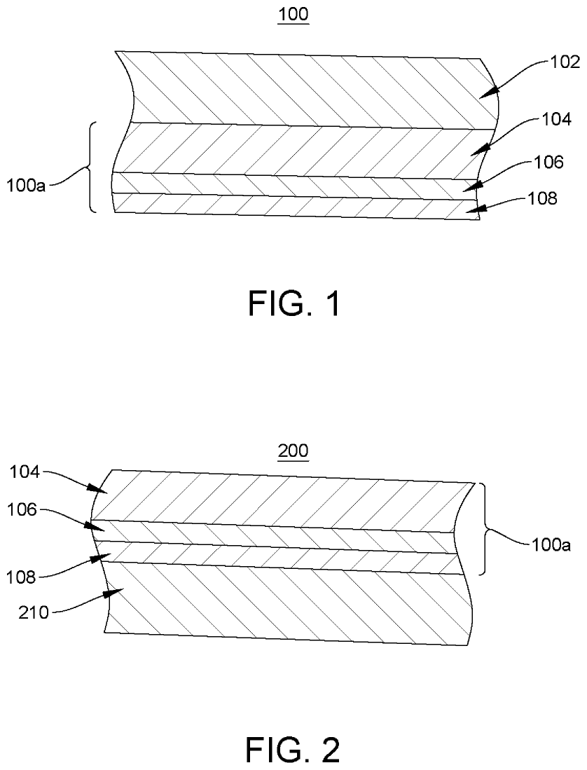

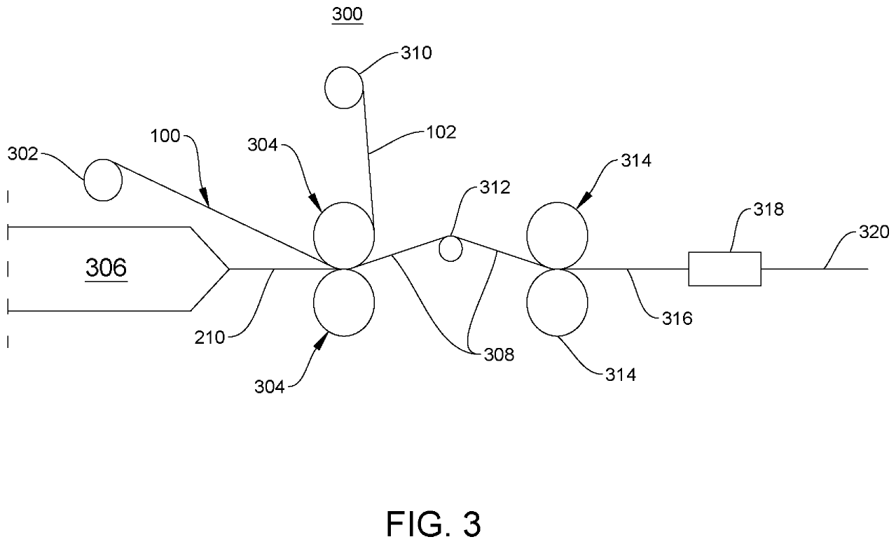

Referring now to FIG. 1 and FIG. 2, the cross-section of a coating 100 is shown in accordance with the various aspects and embodiments of the invention. The coating 100 is manufactured in accordance with the various aspects and embodiment of the invention. The coating 100 includes a removable top cover 102 composed of Biaxially Oriented Polypropylene (BOPP) film.

The top cover 102 is attached to an anti-scratch layer 104. In accordance with the various aspects and embodiments of the invention, during the manufacturing process the top cover 102 is removed before resulting in a partial coating 100a. The partial coating 100a is attached to substrate 210, which is made of PVC. The partial coating 100a includes three layers that collectively, along with the substrate 210, form a product 200. The layers of the partial coating 100a include: the anti-scratch layer 104, a pattern-and-paint layer 106, and a connector layer 108 that allows these layers of the coating 100 to be secured to the substrate 210.

Referring again to FIG. 1 and FIG. 2, The anti-scratch layer 104 is made from a base of a mixture of acrylate resin, methyl methacrylate copolymers, linear or branched acidic functionality monomers with a molecular weight of 40,000-90,000 Daltons and, glass transition temperature (Tg) of 90-110 degrees C., containing ultraviolet (UV) absorbers in solution form or in the form of nano particles.

In accordance with various aspects and embodiment of the invention, some important factors that need to be considered for the anti-scratch layer 104 include: High light resistance; Resistance to chemicals; Resistance to dust and dirt; Resistance to water and weathering; Impact resistance; Scratch resistance; and Performance against weathering, abrasion, and cracking.

In accordance with the various aspects and embodiments of the invention, the anti-scratch layer 104 is reinforced with nano fillers, which makes the product anti-scratch and highly weatherable. In accordance with the various aspects and embodiments of the invention, the use of fillers and the low permeability of the anti-scratch layer 104 surface allows dust and dirt to be easily removed from the surface of the product 200. Moreover, the high weatherability of the layer 104 minimizes the possible degradation of the anti-scratch layer 104 and, hence, the product 200. The coating 100a provides the product 200 greater weatherability compared to conventional vinyl sidings. Specifically, the product 200 has resistance to photodegradation that contributes to longer lifespan. For example, the lifespan of typical or regular vinyl sidings is around 10 years. In contrast, the product 200 will have a lifespan of 15-20 years, resulting in a 50 to 100 percent increase in its productivity and longevity. Another advantage includes positive environmental impacts as the frequency of replacement is significant reduced.

Further and in accordance with the various aspects and embodiments of the invention, the manufacturing process results in the product 200 being a premium siding category, with a thickness range of 0.052 to 0.055 inches.

Referring now to FIG. 3 with reference to FIG. 2 elements, a system 300 is shown that performs the manufacturing process in accordance with the various aspects and embodiments of the invention. The system 300 performs or executes a manufacturing process that adheres the partial coating 100a to the substrate 210 through a transfer operation, thereby producing the product 200.

In accordance with the various aspects and embodiments of the invention, the anti-scratch layer 104 includes additives that reduce its adhesiveness to an emboss roller 314, even at resin glass transition temperature (Tg). The anti-scratch layer 104 is the first layer applied to the surface of BOPP film, such as the top cover 102. The anti-scratch layer 104 thoroughly wets the surface of the top cover 102 and creates uniform coating on the surface of the top cover 102. The anti-scratch layer 104 is so designed that despite the low energy level on the surface of the top cover 102 (the BOPP film), the anti-scratch layer 104 has an acceptable degree of adhesiveness to the surface of the top cover 102 and is easily separated from the surface of the top cover 102 due to the pressure and temperature applied during the transfer operations 300. In accordance with the various aspects and embodiments of the invention, there will be no need for a release layer to separate the anti-scratch layer 104 from the surface of the top cover 102. In accordance with the various aspects and embodiments of the invention, the manufacturing process for creating the coating 100 and use of the system 300 (special equipment), a two-step transfer process 300 is created.

The pattern-and-paint layer 106, which is opposite from the top cover 102 and adjacent/next to the anti-scratch layer 104, creates a beautiful and distinct curb appeal of the product 200. The pattern-and-paint layer 106 has an acrylic-copolymer base with a very high weatherability. The pattern-and-paint layer 106 includes pigments with a high resistance to fading and photodegradation with the proper particle size for filtration of harmful UV rays. Heat absorption by the pattern-and-paint layer 106 has been minimized by using proper pigments. Consequently, during the hot days of the year, the product 200 would provide additional insulation leading to less heat transfer into a home or business.

In accordance with the various aspects and embodiments of the invention, the connector layer 108 links the first two layers to the substrate (PVC layer) 210 through a molecular bond between the two layers. In accordance with the various aspects and embodiments of the invention, the connector layer 108 prevents separation or removal of the anti-scratch layer 104 and the pattern-and-paint layer 106 from the substrate 210.

As discussed herein, the coating 100 includes three layers (104, 106 and 108) that are topped by the BOPP polymer film, such as the top cover 102. In accordance with the various aspects and embodiments of the invention, the manufacturing process for creating the coating 100 is stabilized using high heat and pressure on the surface. The top of the anti-scratch layer 104 possess a preset adhesiveness to the surface of the top cover 102, and under proper conditions, the three layers (104, 106, 108) separate from the top cover 102 and transfer/adhere to the surface of the substrate 210 by the connector layer 108.

Referring now to FIG. 2, FIG. 1, and FIG. 3, a cross-section view of the product 200 is shown according to various aspects and embodiments of the invention. The siding 200 can range in thickness from 0.04 inches to 0.08 inches. More specifically and in accordance with the various aspects and embodiments of the invention, the manufacturing process results in the product 200 being a premium siding category, with a thickness range of 0.052 to 0.055 inches. Those skilled in the art will recognize that the features and benefits of the invention in accordance with the various aspects and embodiments of the invention is not limited by the thickness of the product 200.

In accordance with the various aspects and embodiments of the invention, the substrate 210 is produced from about 95% recycled PVC Acetate (PVC-A) materials, which apart from its compatibility with the polymer of the top layer, has excellent physical properties, and is used in products with a very high toughness. In accordance with the various aspects and embodiments of the invention, this special vinyl siding is used as substrate by adding special additives. The thicker structure of the substrate 210, due to the ability to be manufactured with recycled PVC in its production, allows for a stronger product (such as the vinyl siding panel) that can be wider than the industry standard allowing for an enhanced curb appeal. In accordance with some aspect and embodiment of the invention, the product is siding panel with flat wide shapes of siding, where the wideness could be within 6.5 to 9 inch range. Such wide panels offer advantage over current industry standard siding panels, at least in terms of installation speed and aesthetics. One advantage is that the product 200 is ecologically, technically, and economically sustainable. The product, such as the siding panels with an attractive and unique appearance, can be used for the exterior wall cladding of various buildings. For this reason, it can be a suitable substitute for traditional cladding materials that are not eco-friendly.

Referring now to FIG. 3, FIG. 2, and FIG. 1, a manufacturing process is shown for creating the vinyl siding 200 according to various aspects and embodiments of the invention. The transfer operation of the top layer 100 is made to the bottom substrate 210 under pressure and heat using specialized equipment 300. The process uses a unique two step method in accordance with the various aspects and embodiments of the invention. In the first step, high pressure and heat produced by transfer rollers 304 compress and adhere the coating 100 unto the PVC substrate 210. The rollers 304 can be of any desired diameter. The roller 304 may be filled with a heated liquid to allow for heat transfer in accordance with the various aspects and embodiments of the invention. The heated liquid may be of any composition and heated to any desired temperature. The second step at the embossing rollers 314 produce adjustable patterns, textures and glassiness on the siding before the forming process 318. The rollers 314 are filled with a liquid that is heated and vary in diameter as needed in accordance with the various aspects and embodiments of the invention.

The process of securely adhering the coating 100 to the PVC substrate 210 is detailed as follows: a roll of coating 100 is positioned on a rotating top layer holder 302; the coating 100 is unrolled and proceeds at a predetermined rate of speed from the holder 302 toward a set of heated high pressure transfer rollers 304. Simultaneously, in accordance with the various aspects and embodiments of the invention, a sheet of PVC vinyl siding backing 210 of the same width as the top layer 100 proceeds at the same rate of speed from an extruder 306 toward the transfer rollers 304. The top layer 100 and the PVC backing 210 converge between the transfer rollers 304 where the pressure between the transfer rollers 304 compresses the top layer 100 unto the PVC backing 210 and the heat within the transfer rollers 304 securely adheres the top layer 100 to the surface of the PVC substrate 210 by means of a coating and substrate connector layer 108 forming a section of bonded vinyl siding 308.

As a bonded section of vinyl siding 308 exits from the transfer rollers 304, the removable top cover 102 peels away and is stored for reuse or recycling on a top cover recovery roller 310. The bonded vinyl siding 308 proceeds over a tensioner roller 312 toward embossing rollers 314. At the embossing rollers 314 the bonded vinyl siding 308 is again subjected to high pressure and heat where different types and depths of texture are embossed onto the bonded vinyl siding 308 producing a bonded/textured vinyl siding 316. Finally, the bonded/textured vinyl siding 316 passes through a former 318 where the bonded/textured vinyl siding 316 is formed into the final vinyl siding product 320 ready for sale on the market.

Due to the extreme care used in applying the layers 104, 106 108 to the surface of the BOPP film 102 and using a precision process of transferring the layers 104, 106, 108 to the surface of the siding PVC substrate 210, a uniform and highly durable coating on the siding, free from pores and surface perforations is created. It should be noted that the new transfer system 300 is so designed to involve two steps. The transfer roll 304 step has been separated from the emboss roll 314 step, because the BOPP layer 102 has a very low surface energy level, and the difference between the modulus of elasticity of BOPP 102 and the surface of the coating on the top of the anti-scratch layer 104 ensures there would be no need for a release layer on the BOPP 102 surface. This has made it possible to not only reduce the price but also results in the BOPP film's 102 recyclability. As another advantage, the desired glassiness would have no relation to the BOPP 102 surface, instead, the glassiness of the final product can be altered by adjusting the glassiness of the emboss roll 302 glassiness. Because of changing to a two-step transfer process, the thickness of the BOPP film 102, on which the coating is printed, will have no effect on the emboss depth, and that a film with a greater thickness can be used, which not only facilitates the printing but also makes the transfer a lot easier.

Due to the direct application of high pressure and heat to the coating surface 104, using the emboss roll 302 without the BOPP film 102, a better bonding is created between PVC 210 and the coating and substrate layer connector 108, drastically reducing the possibility of delamination.

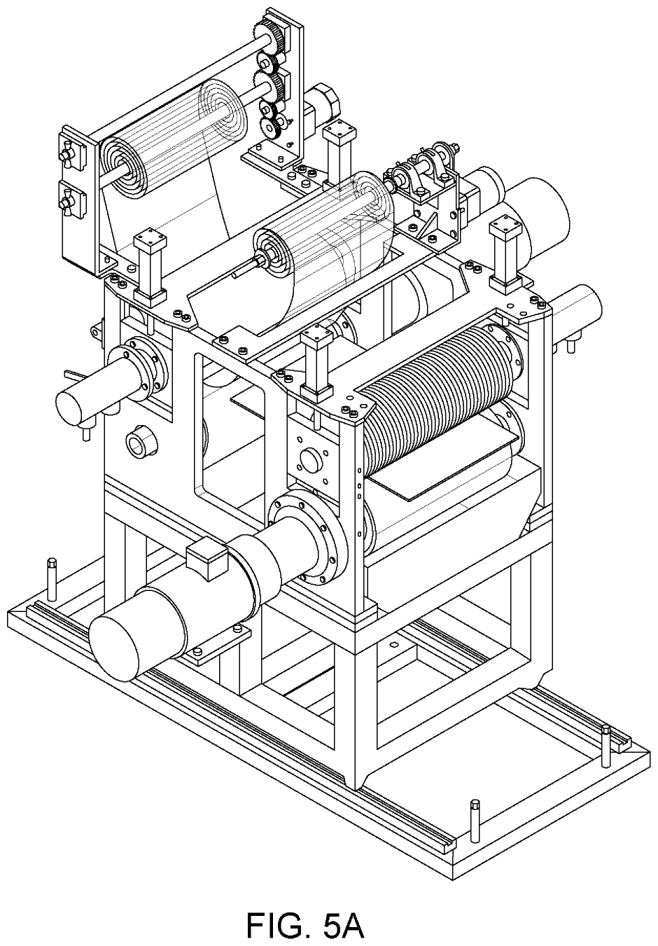

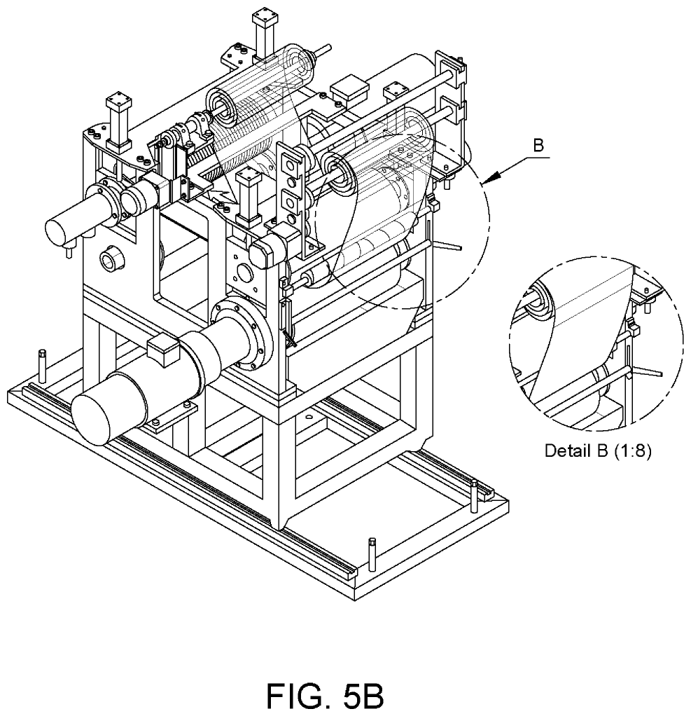

In accordance with the various aspects and embodiments of the invention, FIG. 5A and FIG. 5B show an example of a system is shown for executing the manufacturing process and includes 4 main components, hardware and/or: 1) Unrolling system; 2) Rolling system; 3) Transfer roller system; and 4) Emboss roller system.

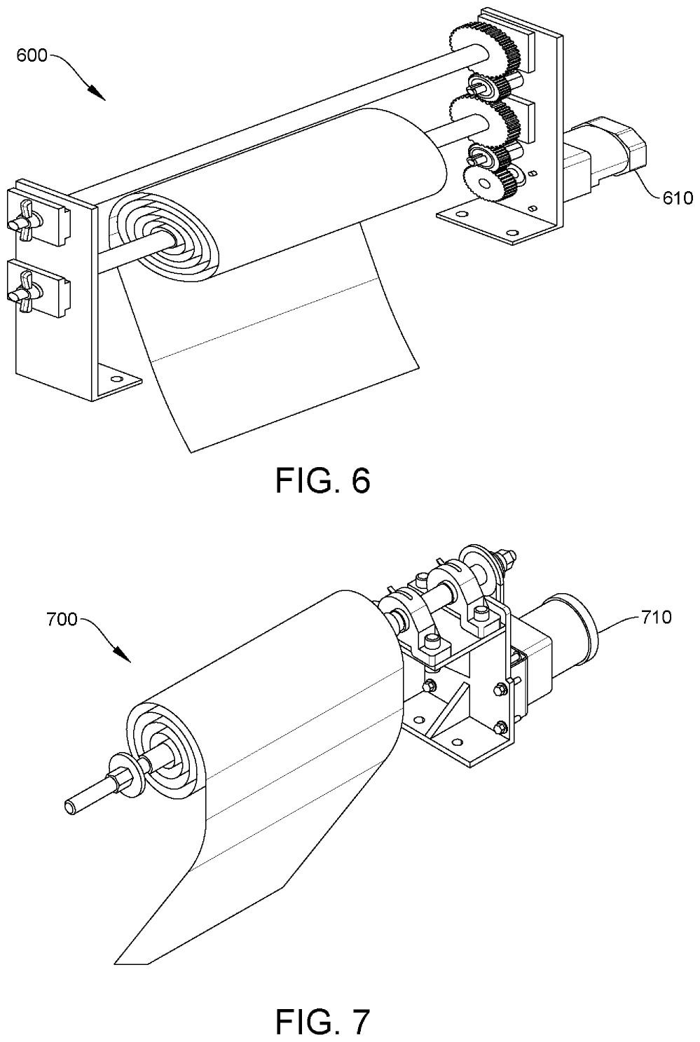

Referring now to FIG. 6, an unrolling system 600 is shown in accordance with the various aspects and embodiments of the invention. The unrolling system 600 is designed to be able to assemble the new roller on the machine without stopping production. Due to the fact that the process of transfer and penetration of the design (the coating) on the main PVC surface (the substrate) is very sensitive, has to be accurate, and requires an accurate schedule, the unrolling system 600 must unroll the film (and the design) according to a specific time to reach the primary goal. The primary goal of the system is to secure continuous production and to perpetuate seamless transitions between any number of successive rolls. In accordance with the various aspects and embodiments of the invention, the unrolling system 600 includes a module 610 that performs various functions, including motor functions, such as an electric brake, consistently applying tension to the film across all speeds and is installed with a special gearbox and multiple gears to perform the act of opening the plastic film roll evenly and continuously. The choice of engine and gearbox, as well as the speed of opening the roll, have been obtained according to the results of many tests. The starting and stopping of this system is fully coordinated with a transfer roller system and an embossing roller system (discussed below), and such coordination and speed setting of the system 600 are controlled by a control circuit and Programmable Logic Controller (PLC) device.

Referring now to FIG. 7, a rolling system 700 is shown in accordance with the various aspects and embodiments of the invention. The system 700 is very accurate and designed so that the used film roll can be taken out of the machine without stopping production. As discussed with respect to the unrolling system 600, in order to complete the transfer operation, the timing of the unrolling system 600 and the rolling system 700 is very important. The rolling system 700 is equipped with its own motor module 710. The motor module 710 includes various functions (including gearing and braking) and features, such as tension control to ensuring the film stretches uniformly across varying speeds. 710. If for any reason the action of unrolling is done faster than the appropriate time; the designs on the plastic film roll are stretched and the ratio of the length to the width of the designs is messed up, which results in incorrect or inappropriate shapes being placed on the substrate of the product. To prevent this action, the unrolling system 600 starts to move and rotate by a special motor and gearbox, the moment of starting and stopping its rotation is done by the control circuit that receives the orders from the PLC device.

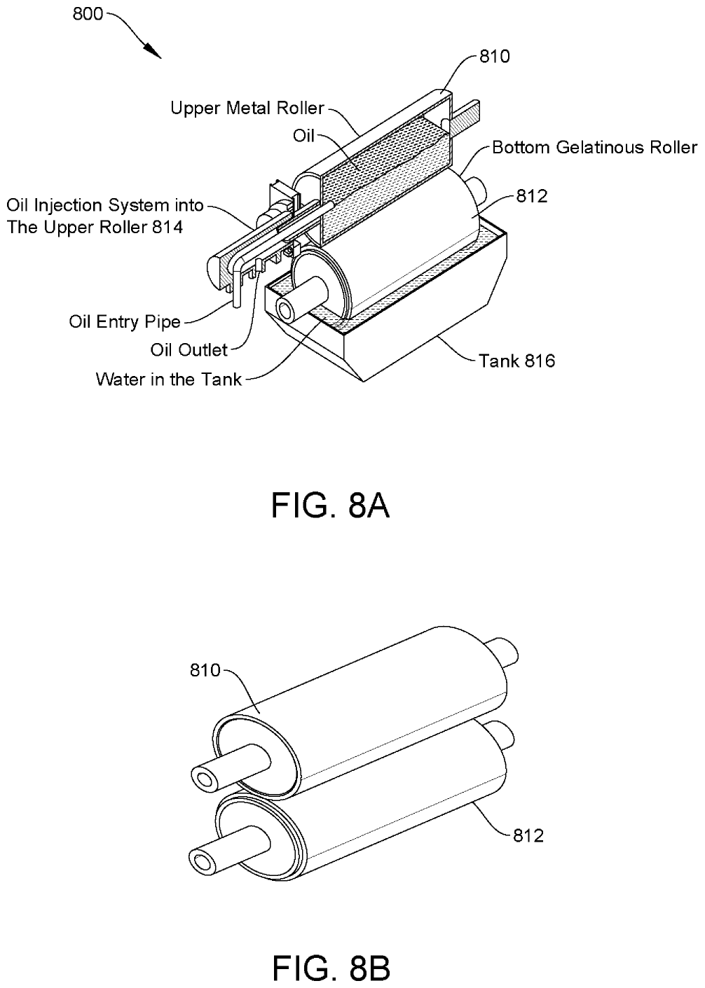

Referring now to FIG. 8A and FIG. 8B, a transfer roller system 800 is shown In accordance with the various aspects and embodiments of the invention. The transfer roller system 800 includes 2 main rollers, an upper metal roller 810 and a bottom gelatinous roller 812. The rollers 810 and 812 apply a force on each other and induce rotation. In accordance with the various aspects and embodiments of the invention, the upper roller 810 is made of metal, which has been coated with Chromium with great precision. One of the features in the construction of the upper roller 810 is its very smooth surface and its flat chromium coating. When the main PVC and a roll of designed film are placed between the upper roller 810 and the bottom roller 812, the printing process and the plan are transferred. Furthermore, there are very specific conditions at this stage that will be explained later. At the same moment as the transfer operation is done, the used film must be separated from the surface of the original PVC tape. One of the substantial points for separating the film and the designed roll is the coverage and uniformity of the transfer roller system 800. The bottom roll is composed of two types of materials and different layers. The lower layer is made of metal, which preferably has anti-rust and oxidation plating. The bottom layer, which is involved with the bottom roller 812, is made of silicone rubber with a hardness of 45-55 (shore A) with the ability to cool in the water, as shown with a tank filled with water.

In accordance with the various aspects and embodiments of the invention, the transfer roller system 800 includes a control system, for accurate control of the height as well as the appropriate force and pressure of the upper roller 810 facing the bottom roller 812. In accordance with the various aspects and embodiments of the invention, the thickness of the main sheet of PVC tape at the moment of entering the transfer roller system 800 is in the range of 0.04 to 0.08 inches and its tolerance in this process is about 100 microns. The applied pressure and movement of the rollers (the upper roller 810 and the bottom roller 812) along the Z axis are controlled.

In accordance with the various aspects and embodiments of the invention, the transfer roller system 800 includes a steering controller module that controls the pressure and adjustment of the movement of the upper roller 810. In addition, this pressure completely depends on the hardness of the bottom roller 812, which is constantly checked by a control circuit and adjusted depending on the temperature of both rollers.

Referring to FIG. 8A, the transfer roller system 800 includes a heating system In accordance with the various aspects and embodiments of the invention. In the process of transferring the film onto the substrate (or the main PVC tape), the temperature of both rollers (the upper roller 810 and the bottom roller 812) are controlled. In order to heat the upper roller to the point where the film (the anti-scratch layer, the pattern-and-paint layer, and the connector layer) is transferred onto the main tape (the top cover 102). Oil, which is maintained at a predetermined temperature, flows consistently from the inlet to the outlet. The hot oil enters the upper roller 810 from an entry point controller by a circuit 814. After the oil reaches a suitable volume and transfers its heat to the body of the upper roller 810, the oil leaves through a separate path. Then the process is repeated that starts the heating cycle again. In accordance with the various aspects and embodiments of the invention, in order to prevent the rollers of this system from overheating, a water tank 816 is installed under the bottom roller 812. The water in the tank 816 is constantly circulating to reduce the temperature of the lower roller outside the device by the cooling radiator. The water in this closed cycle keeps the temperature of the transfer roller system 800 constant.

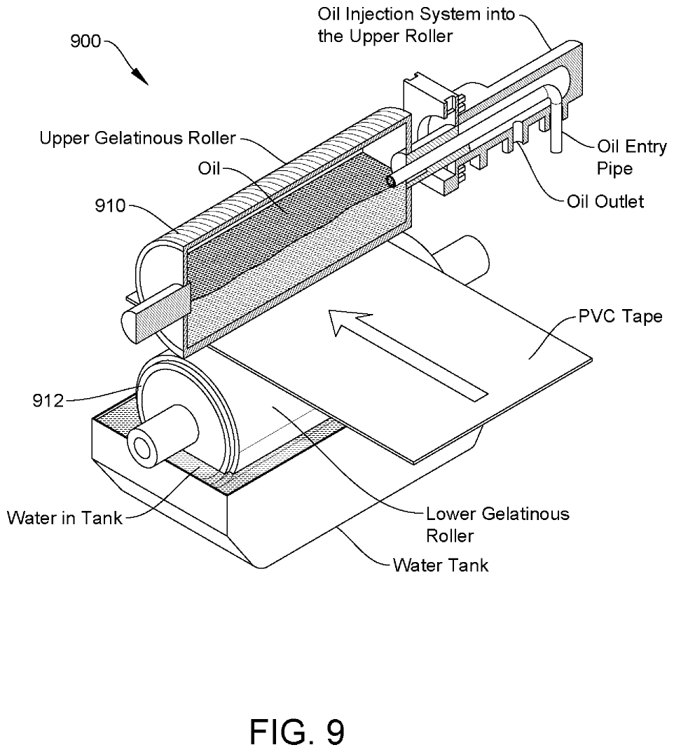

Referring now to FIG. 9, an emboss roller system 900 is shown in accordance with the various aspects and embodiments of the invention. After the process of transferring the design to the original PVC tape, embossing occurs on the patterned PVC. At this stage of the process, the surface of the main PVC should have ridges and depressions so that both the beauty of the design is more obvious and the top surface of the main PVC takes on a more natural effect and the design has a lively state. The partially finished product reaches the emboss roller system 900. In accordance with the various aspects and embodiments of the invention, 2 rollers are used: an upper gelatinous roller 910 having a groove-like design and a lower Silicone rubber roller 912 that is made of Silicone rubber roller with a hardness of 45-55 (shore A). The emboss roller system 900 applies pressure and makes ridges and depressions in the main PVC surface, which is the coated substrate and passing between these 2 rollers.

In accordance with the various aspects and embodiments of the invention, the emboss roller system 900 includes a control system for adjusting the depth of emboss grooves by adjusting the position of the upper roller 910 relative to the lower roller 912. Therefore, the control system should be designed carefully to control the height and, hence, the force and pressure between the upper roller 910 facing the lower roller 912.

In accordance with the various aspects and embodiments of the invention, because of the high force of the emboss roller and the high adhesion of the main tape design to the embossing roller, a special coating is used for surface of the upper roller 910, such as Ni—Cr coating.

In accordance with the various aspects and embodiments of the invention, the emboss roller system 900 includes a temperature stability control module. The temperature stability control module handles the temperature of the upper roller 910 (through the oil passing therethrough) and the temperature water for of the lower roller 912, which is cooled by water.

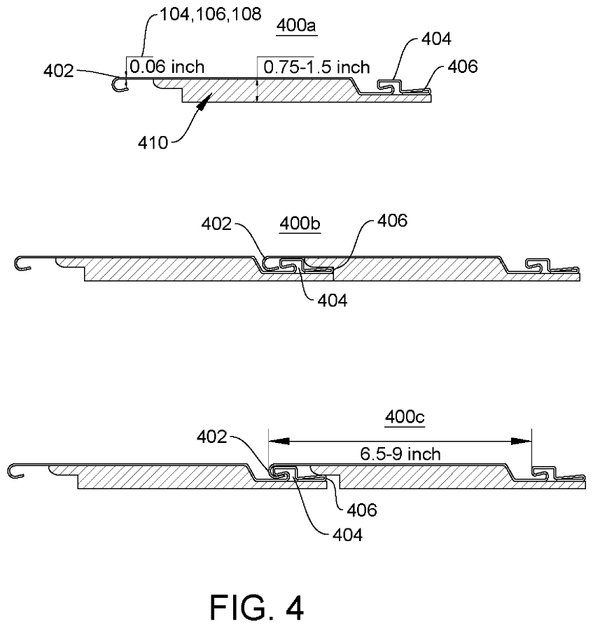

Referring now to FIG. 4 along with FIG. 2 and FIG. 1, a cross-sectional view of a product 400a, such as a manufactured panel of vinyl siding, is shown in accordance with the various aspects and embodiments of the invention. The product 400a includes a hook-shaped end that forms a male connector end 402 that couples with a female connector end 404 on an adjacent panel during installation. The nailing hem 406 supports the next connecting vinyl panel when it is installed to maintain a uniform flat surface to the siding for enhanced curb appeal in accordance with the various aspects and embodiments of the invention.

In accordance with the various aspects and embodiments of the invention, a cross-sectional view of two products 400b, such as a manufactured panels of vinyl siding, are shown. The products 400b show the installation of two mating panels in accordance with the various aspects and embodiments of the invention. The hook-shaped male connector end 402 is positioned to slide over and lock onto the female connector end 404. The nailing hem 406 is in position to fix the panels to the wall and to hold the outer surfaces of the two adjacent panels on the same level plane once the male connector end 402 and the female connector 404 are slid together.

The assembly products 400c are shown when the installer slides the two adjacent panels together forming a secure attachment, which locks the two adjacent vinyl siding panels together. The nailing hem 406 is holding the panel to the wall and holding the two installed vinyl siding panels on a level plane. The process is repeated using products 400b through 400c until the desired amount of product (such as vinyl siding) is installed.

The hook-shaped male connector end 402 is an extension of the product 200, which includes the top coating illustrated in FIG. 1 composed of layers 104, 106, 108, and the layer 210. The layers 104, 106 and 108 also cover the entire surface of the female connector end 404 and the nailing hem 406. When the male connector 402 and the female connector 404 engage, they form a secure watertight connection between the installed vinyl siding panels. Under the vinyl siding 200 is a foam base 410 as illustrated in FIG. 4 in accordance with the various aspects and embodiments of the invention. The foam base 410 acts as an insulation as well as support in accordance with the various aspects and embodiments of the invention. The foam can range in thickness from 0.5 inches to 2.0 inch.

Certain examples have been described herein and it will be noted that different combinations of different components from different examples may be possible. Salient features are presented to better explain examples; however, it is clear that certain features may be added, modified, and/or omitted without modifying the functional aspects of these examples as described.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments and aspects that are shown and described herein. Rather, the scope and spirit of the invention is embodied by the appended claims.

What is claimed is:

1. A method of manufacturing a product, the method comprising:
extruding a substrate;
coating the substrate with high optical properties and print quality to produce a coated substrate, wherein the coating substrate includes:
a first layer having a connector layer that coats and adheres to the substrate;
a second layer adhering to the first layer, wherein the second layer includes at least one of color and pattern; and
a third layer adhering to the second layer, wherein the third layer is an anti-scratch protective layer;
high pressure pressing the coated substrate to reinforce the bond between the coating and the substrate to produce an integrated product;
shaping the integrated product to form the product.

2. The method of claim 1, wherein the product is vinyl siding and wherein the coating replicated the appearance of natural materials.

3. The method of claim 1 further comprising a top cover that can be separate from the third layer while the substrate is being coated, wherein the top cover is repurposed or recycled.

4. A vinyl siding system comprising:
a first vinyl siding piece including:
a first body;
a first male end on one side of the first body, wherein the first male end forms a hook shape; and
a first female end at an opposite side of the first body from the first male end, wherein the first female end includes:
a first tab end that is shaped to receive and securely engage a male end of another vinyl siding piece; and
a first nailing hem defined opposite the first tab end for supporting a body of the other vinyl siding; and
a second vinyl siding piece including:
a second body;
a second male end on one side of the second body, wherein the second male end forms a hook shape; and
a second female end at an opposite side of the second body from the second male end, wherein the second female end includes:
a second tab end that is shaped to receive and securely engage a male end of another vinyl siding piece; and
a second nailing hem defined opposite the second tab end for supporting a body of the other vinyl siding piece.

5. The vinyl siding system of claim 4, wherein design uniqueness of the first vinyl siding piece and the second vinyl siding piece makes it possible to install in at least one of horizontal orientation and vertical orientation.
